(19) United States
(12) Patent Application Publication
(10) Pub. No.: US 2023/0149843 A1
(43) Pub. Date: May 18, 2023

(54) METHOD FOR MOLDING A SEALING DEVICE ONTO AN END FOLD OF A BELLOWS, CASTING SHELL ASSEMBLY AND FILTER ELEMENT

(71) Applicant: MANN+HUMMEL GmbH, Ludwigsburg (DE)

(72) Inventors: Thomas LOEHL, Mundelsheim (DE); Thilo MUELLER, Karlsruhe (DE)

(21) Appl. No.: 18/092,877

(22) Filed: Jan. 3, 2023

Related U.S. Application Data
(63) Continuation of application No. PCT/EP2021/067856, filed on Jun. 29, 2021.

(51) Int. Cl. B01D 46/00; F02M 35/024

(52) U.S. Cl. CPC B01D 46/0005; B01D 46/0001; F02M 35/0245; F02M 35/02408; B01D 2271/025

(57) ABSTRACT

In a method for molding a sealing device onto an end fold of a pleated bellows, wherein the end fold comprises an outer side and an inner side, the pleated bellows arranged in a casting shell assembly is embedded in a curable sealing material, limited at a rim of the pleated bellows by a casting chamber formed by the casting shell assembly. Expansion of the curable sealing material is reduced or prevented by a limitation element contacting the inner side of the end fold. A casting shell assembly has top and bottom casting shell parts forming a casting chamber to mold a sealing device onto the end fold of the pleated bellows by a sealing material. The bottom casting shell part has a channel for receiving the sealing material. The channel has an upwardly projecting limitation element for engaging an inner side of the end fold.

### CROSS-REFERENCE TO RELATED APPLICATIONS

This application is a continuation application of international application No. PCT/EP2021/067856 having an international filing date of 29 Jun. 2021 and designating the United States, the international application claiming a priority date of 3 Jul. 2020 based on prior filed German patent application No. 10 2020 117 606.6, the entire contents of the aforesaid international application and the aforesaid German patent application being incorporated herein by reference.

### BACKGROUND OF THE INVENTION

The present invention concerns a method for molding a sealing device onto an end fold of a pleated bellows folded in a zigzag shape, a filter element obtainable by the method, and a casting shell assembly.

DE 10 2012 005 530 A1 describes a method for producing a filter element provided with a seal part in which the sealing material is introduced in an uncured state into a casting chamber between two casting shell parts. A compensation chamber for expansion of the sealing material is provided which is connected to the casting chamber.

In such a manufacturing method, the sealing material can expand, during curing, into folded regions of the pleated bellows and cover filter surface. Sections of the pleated bellows covered with sealing material can then not be used for filtering a fluid.

In view of this background, it is the object of the present invention to provide an improved method for manufacturing a seal on a filter element and means for such a manufacture. Furthermore, a corresponding filter element is to be provided.

### SUMMARY OF THE INVENTION

Accordingly, a method for molding a seal device onto an end fold of a pleated bellows folded in a zigzag shape is proposed in which the pleated bellows folded in a zigzag shape and arranged in a casting shell assembly is embedded in a curable sealing material, limited at the rim side by a casting chamber formed by the casting shell assembly. The end fold comprises an outer side and an inner side. An expansion of the curable sealing material is reduced or prevented, in particular in the direction of neighboring folds, by means of a limitation element which is contacting the inner side of the end fold. In a simple and inexpensive manner, it is ensured in this way that the filtration surface of a fold section neighboring the end fold at the finished filter element is reliably free of cured sealing material as desired, in other words, is not covered by cured sealing material, and can be flowed through reliably for filtering the fluid in the obtained filter element.

Furthermore, a casting shell assembly is proposed with a bottom casting shell part and a top casting shell part for forming a casting chamber for molding a sealing device onto an end fold of a pleated bellows folded in a zigzag shape by means of a pourable curable sealing material. The bottom casting shell part comprises a channel for the sealing material with an upwardly projecting limitation element for engaging an inner side of the end fold.

Furthermore, a filter element with a pleated bellows folded in a zigzag shape and a sealing device is proposed in which the sealing device, by means of the method described above or described in the following, is molded onto the pleated bellows, in particular by use of an embodiment of the casting shell assembly.

The filter element comprises in particular a pleated bellows of a filter medium folded in a zigzag shape and a sealing device which comprises a cured sealing material molded on according to the method.

The sealing device is in particular a flexible and compressible seal, for example, of PUR foam, which is fixedly connected to the pleated bellows. The sealing device which is molded at the rim side onto the pleated bellows covers in particular a rim section of the outer side and of an inner side of an end fold of the pleated bellows at least partially and is at least substantially spaced apart from a fold section which is neighboring the end fold. In particular, the fold section which is neighboring the end fold and further fold sections of the pleated bellows are free of the sealing device and can be used for a filtration of a fluid. The filter element can comprise in particular a fold section which is neighboring an end fold and is substantially free of cured sealing material of the sealing device. The fold section can be configured to be flowed through in particular for filtration of the fluid to be filtered. In particular, the filter element does not comprise a rigid plastic frame but only a molded-on flexible seal. In this way, the filter element can be manufactured inexpensively and the filter element can be installed in a simple manner in a corresponding filter housing due to the flexibility.

The filter element manufactured with the method can be suitable in particular for filtering air. The filter element is in particular an air filter element. For example, the filter element with the sealing device can be suitable for filtering the cabin air or combustion air of motor vehicles.

The pleated bellows folded in a zigzag shape is, for example, a pleated bellows of a paper material or a nonwoven material. The filter bellows folded in a zigzag shape in other words is a filter medium which comprises a plurality of fold sections folded at fold edges. The end fold is a fold section that delimits the pleated bellows outwardly. In particular, the outer side of the end fold forms an outer rim of the pleated bellows. The inner side of the end fold is positioned opposite the outer side. The neighboring fold section is a fold section which is folded relative to the end fold at a fold edge.

The pleated bellows folded in a zigzag shape comprises in particular an inflow side or raw side along first fold edges at which the unfiltered fluid enters the pleated bellows. Furthermore, the pleated bellows comprises an outflow side or clean side along second fold edges which are opposite the first fold edges. At the outflow side, the filtered fluid exits from the pleated bellows. A circumferentially extending rim connects the inflow side and the outflow side. The outer side of the end fold forms a section of the circumferentially extending rim of the pleated bellows.

For fixation of the fold sections, the pleated bellows folded in a zigzag shape can comprise a lateral strip which is attached on or at the rim-side pleated profiles. The lateral strip can be, for example, of nonwoven, a rigid or flexible plastic material, paper or cardboard and/or can be of a filter material.

The casting chamber which is formed by the casting shell assembly serves for receiving the curable sealing material in liquid, viscous and/or foamed state and for expansion of the sealing material upon curing. In particular, the casting chamber serves for rim-side embedding of the pleated bellows with the liquid, viscous, and/or foamed sealing material. A rim-side embedding of the pleated bellows is realized in particular in such a way that the inner side and the outer side of the end fold are at least partially embedded. A rim-side embedding, for example, can comprise also a partial embedding of the lateral strip attached to the pleated profiles. A rim-side embedding, for example, can also comprise a circumferential embedding of the pleated bellows.

Liquid, viscous and/or foamed sealing material is to be understood presently such that the sealing material preferably is liquid, viscous and/or foamed only during processing, in particular during filling into the casting chamber. After filling into the casting chamber, the sealing material enlarges its volume, e.g., by foaming, and can solidify by curing for forming the sealing device so that after curing it is no longer liquid, viscous and/or foamed. During curing of the sealing material, the sealing material expands in the casting chamber for forming the sealing device. In particular, the casting shell assembly and the limitation element form a contour which hinders the liquid, viscous and/or foamed sealing material from expanding during filling and during curing.

The bottom casting shell part comprises in particular a closed channel into which the liquid sealing material can be poured. Advantageously, the channel is designed as a circumferentially extending channel. With a circumferentially extending channel, a circumferentially extending sealing device can be molded onto the pleated bellows.

In embodiments, the limitation element is formed as one piece together with the bottom casting shell part and delimits in particular at an inner side a circumferentially extending channel. Advantageously, two limitation elements are provided which respectively delimit inwardly the circumferentially extending channel at opposite sides. In this way, in case of a pleated bellows extending in longitudinal direction between two end folds, the inner sides of the two end folds can contact respectively a limitation element.

The limitation element is in particular configured such and/or arranged at the bottom casting shell part such that it projects upwardly away from the bottom casting shell part. The limitation element, for example, can form a rim of the circumferentially extending channel which projects farther upwardly than a second rim of the channel.

In embodiments, the limitation element is formed as a spring element that is attached to the channel or is integrally molded as one piece with the channel. A limitation element embodied as a spring element is to be understood here as a limitation element which upon insertion of the pleated bellows into the bottom casting shell part is at least flexible to a minimal extent so that an insertion of the pleated bellows is simplified. For example, an outward restoring force of the spring can be adjusted such that the end fold is pushed away from the neighboring fold section and is pushed in a direction toward the channel of the casting shell assembly. The spring element, for example, can be embodied as a thin plastic leaf or as a metallic leaf spring, in particular of aluminum or spring steel. The limitation element can furthermore be embodied as one piece together with the bottom casting shell part, for example, as a thin upwardly projecting rim of the channel, or connected thereto as a separate component.

The limitation element contacts in particular the inner side of the end fold such that it presents a limitation of the sealing material which is expanding and hinders or completely prevents an expansion of the sealing material along the inner side in upward direction and/or in the direction toward the neighboring fold section beginning at an adjustable rising height of the expanding sealing material.

In embodiments, the casting shell assembly and/or the limitation element can also be designed such that the limitation element in addition contacts a side of the neighboring section which is facing the inner side of the end fold or contacts only the side of the neighboring section which is facing the inner side.

Since the expansion of the sealing material expanding upon curing is reduced or prevented by means of the limitation element, an expansion of the sealing material into further fold sections of the pleated bellows is prevented or at least limited. In this manner, the additional fold sections of the pleated bellows remain free of expanding sealing material. In this way, with the method a reduced number of fold sections of the pleated bellows are covered and closed off by the sealing material as it would be the case in a method without the limitation element.

Fold sections covered by the sealing material can filter less or no fluid. In this way, due to the reduction or prevention of the expansion of the expanding sealing material by means of the limitation element, the usable portion of the pleated bellows is enlarged. In this way, a filter element with an improved filtration performance can be manufactured. Thus, smaller filter elements with the same filtration performance can be manufactured. Furthermore, an installation space for the improved filter element can be designed to be smaller in this way. Moreover, fluctuations of the usable portion of the pleated bellows between several filter elements manufactured by the method can be avoided because a better defined shaping of the sealing material as it cures can be realized by the respective limitation section.

In embodiments, the casting shell assembly comprises a top casting shell part and a bottom casting shell part and the method comprises at least one of the steps:

arranging the pleated bellows folded in a zigzag shape in or at the top casting shell part;

introducing the curable sealing material in the uncured state into a circumferentially extending channel of the bottom casting shell part at which the limitation element projects upwardly;

arranging the top casting shell part with the pleated bellows folded in a zigzag shape at the bottom casting shell part in such a way that the limitation element at least partially contacts the end fold at the inner side;

curing of the sealing material for forming the sealing device, wherein the sealing material expands upon curing; and/or

removing the pleated bellows with the sealing device from the casting shell assembly.

The pleated bellows folded in a zigzag shape is in particular arranged such in or at the top casting shell part that the outer side of the end fold is arranged at a lateral contact surface of the top casting shell part, in particular placed against it. For example, a holding element or the like can be provided also which holds the outer side of the end fold at the lateral contact surface of the top casting shell part, in particular holds it in position.

The curable sealing material in the uncured state is in particular filled as a liquid sealing material into the circumferentially extending channel of the bottom casting shell part. Filling in the sealing material in the uncured state is realized, for example, with the aid of a metering head. The metering head can be guided, for example, by a robot. The bottom casting shell part and the limitation element are designed such and arranged at each other such and/or a quantity of filled-in curable sealing material is metered such that the limitation element at the channel projects past the filled-in liquid sealing material in upward direction.

The top casting shell part with the pleated bellows folded in a zigzag shape is joined at the bottom casting shell part such that the limitation element engages between the end fold and the neighboring fold section. For example, the limitation element holds the end fold at a distance to the neighboring fold section when arranging the casting shell parts and during curing of the sealing material. For example, the limitation element pushes the end fold against the top casting shell part, in particular against the lateral contact surface of the top casting shell part.

In embodiments of the method in which a spring element at the channel of the bottom casting shell part is used as a limitation element, the spring can be bent, for example, such that the spring contacts the inner side of the end fold and the side of the neighboring fold section facing the inner side when arranging the casting shell parts. In this way, the spring due to its restoring force can push the inner side against the top casting shell part, in particular the lateral contact section of the top casting shell part. Moreover, the spring can better hold the end fold and the neighboring fold section at a distance during arranging of the casting shell parts and curing of the sealing material as it is possible for a limitation element without restoring force.

The arrangement of the top casting shell part at the bottom casting shell part is realized in particular such that between them the casting chamber is formed for filling in the curable, in particular liquid, sealing material, and for expansion of the sealing material during curing. The casting chamber comprises in particular a volume which is formed by the circumferentially extending channel. Above the volume that is formed by the channel, the casting chamber comprises a top expansion region for expansion of the sealing material which is being cured. The arrangement of the top casting shell part with the pleated bellows folded in a zigzag shape at the bottom casting shell part is realized in particular such that the end fold of the pleated bellows is introduced into the top expansion region. A quantity of filled-in liquid sealing material is preferably measured such that the sealing material upon curing expands into the top expansion region and along the end fold and is prevented from expanding farther by the limitation element. In this way, during curing of the sealing material, the end fold at least partially is covered with the curing sealing material and further fold sections remain free of sealing material.

In embodiments, the casting chamber is formed such that the curable sealing material at least partially covers the outer side and the inner side of the end fold.

In this way, the end fold is embedded by foaming from two sides in sealing material so that a sealing device which is fixedly connected to the end fold can be molded onto the pleated bellows.

In embodiments of the casting shell assembly, the top and the bottom casting shell parts form the casting chamber such that an upwardly open slot for insertion of the end fold is present between the limitation element and a corresponding wall of the top casting shell part.

Upon arranging the casting shell parts on each other, the end fold of the pleated bellows arranged at the top casting shell part is at least partially introduced into the slot. Upon curing, the sealing material expands at least partially into the slot. In this way, the end fold can be surrounded well with the sealing material as it cures.

In embodiments, the casting shell assembly can also be designed as one part and comprise only a single casting shell part at which the limitation element projects upwardly. In embodiments of the method, which employ such a one-part casting shell assembly, the liquid sealing material is filled into a channel, in particular a circumferentially extending channel, of the one-part casting shell assembly, and the pleated bellows is arranged such at the one-part casting shell assembly that the limitation element at least partially contacts the inner side of the end fold.

In embodiments, the limitation element is arranged such between the inner side of the end fold and a neighboring fold section that the expansion of the curable sealing material in the direction toward the neighboring fold section is prevented.

In this way, the sealing material cannot expand beyond the end fold into the neighboring fold section and into further fold sections of the pleated bellows and cover them. The neighboring fold section which thus remains free of the sealing material and the further fold sections which also remain free of the sealing material can thus be utilized for the filtration of the fluid. Moreover, independent of the precise positioning of the pleated bellows in the casting shell assembly and independent of the precise size of the pleated bellows, maximally only the end fold will be covered with the sealing material.

In embodiments, the curable sealing material comprises a material which expands upon curing, in particular a plastic material, in particular PUR foam.

In embodiments, the volume of the filled-in liquid sealing material upon curing expands by 100% to 150%, in particular it expands by about approximately 120%.

In embodiments, the pleated bellows folded in a zigzag shape is held and positioned at the top casting shell part by means of spring elements, in particular by means of spring elements fastened at the sidewalls of the top casting shell part.

The spring elements of the top casting shell part are arranged, for example, in the top casting shell part and clamp the intermediately positioned pleated bellows. In this way, a tension on the pleated profiles in the direction of the folds can be realized and/or the pleated bellows can be compressed slightly and held transversely to its zigzag-shaped folds by means of the spring elements. Since the pleated bellows is held and positioned at the top casting shell part by means of the spring elements, the spring element or limitation element can be positioned more easily and more precisely at the top casting shell part. Moreover, the pleated bellows upon arrangement of the top casting shell part at the bottom casting shell part can be held at the top casting shell part such that it does not detach from the top casting shell part. Due to the holding of the pleated bellows in position by means of the spring elements, the limitation element can be introduced better between the end fold and the neighboring fold section.

In embodiments, the limitation element extends at least across 30% of the length of the end fold, preferably at least across 50%, further preferred at least across 80% of the length of the end fold.

In embodiments, it can be expedient to use sealing material for supporting the fold edges. In particular, one or a plurality of flat knobs of sealing material are molded integrally on the sealing device. For this purpose, the casting shell has one or a plurality of depressions into which the sealing material can flow. Advantageously, the rib-shaped limitation element then comprises one or a plurality of recesses corresponding to the depression or the depressions. The cured sealing material forms a knob which extends across the end faces of 1 to 3 folds. When a foamed sealing material is used, the knob is not only contacting the fold tip but surrounds the fold tip across a minimal height, for example, by up to 3 mm.

A plurality of limitation elements can be provided along the channel which, along the end fold of the filter element, delimit in sections the expansion of the sealing material as it cures toward the inner side of the end fold. In embodiments, the limitation element forms a thin wall and/or is attached plate-shaped or strip-shaped at the casting shell part. In embodiments, the bottom casting shell part has two limitation elements positioned opposite each other at opposite sides.

In embodiments, a sealing device surrounding the filter element is formed along an outer edge by means of the casting shell assembly. The object is furthermore solved by a filter element which comprises a pleated bellows of a filter medium folded in a zigzag shape and a sealing device molded onto the rim side, wherein the sealing device molded onto the rim side of the pleated bellows at least partially covers a rim section of an outer side and of an inner side of at least one end fold of the pleated bellows and is spaced apart from a fold section neighboring the end fold at least across a substantial length of the neighboring fold section. The sealing device can be embodied to circumferentially extend about the pleated bellows and is spaced apart from the neighboring fold sections at least outside of a circumferentially extending rim region of the pleated

In an embodiment, the fold section which is neighboring the end fold of the pleated bellows is substantially free of cured sealing material of the sealing device. Substantially free means that, outside of an end face rim region, i.e., a narrow rim region of approximately 5 mm extending from the pleated profiles in the direction toward the bellows inner side, and with the exception of defined attached tongues or knobs of sealing material extending from the end fold across one or a plurality of neighboring fold edges, the sealing material has no contact with the neighboring fold sections.

The end fold is a fold section which delimits the pleated bellows outwardly, wherein the outer side of the end fold forms an outer rim of the pleated bellows and wherein the inner side of the end fold is positioned opposite the outer side. The neighboring fold section is a fold section which is folded relative to the end fold at a fold edge.

According to an advantageous embodiment, the fold section can be flowed through for filtering the fluid to be filtered. In particular, the fold section neighboring the end fold and further fold sections of the pleated bellows are substantially free of the sealing device. The sealing device frames only the end folds and optionally the end faces of the pleated bellows. Sealing material covers only the end fold. An exception is made only by defined stabilization knobs in the form of narrow tongues or knobs which minimally cover the end fold and one up to three additional fold sections.

The cured sealing material of the sealing device is or comprises advantageously a material which expands upon curing, in particular a plastic material, in particular PUR foam.

The cured sealing material of the sealing device covers advantageously at least partially the outer side and the inner side of the end fold.

### BRIEF DESCRIPTION OF THE DRAWINGS

FIG. 1 shows a schematic perspective view of a pleated bellows folded in a zigzag shape, used in a method for molding a sealing device according to a first embodiment, and of the molded-on sealing device.

FIG. 2 shows a partial view of FIG. 1.

FIG. 3 shows a cross section view of a casting shell assembly used in the method and of the pleated bellows in a state arranged on each other and filled with a sealing material during the process.

FIG. 4 shows a view of a bottom casting shell part and of a top casting shell part of the casting shell assembly of FIG. 3.

FIG. 5 shows a schematic perspective principle illustration of the casting shell assembly and of a filter element obtained by the method according to the first embodiment.

FIG. 6 shows a partial cross section view of the sealing device molded onto the pleated bellows in accordance with the method according to the first embodiment.

FIG. 7 shows a cross section view of a bottom casting shell part of a casting shell assembly which is used in a method for molding a sealing device onto the pleated bellows according to a second embodiment.

FIG. 8a shows a schematic perspective view of a filter element according to the invention.

FIG. 8b shows a schematic detail view of the filter element of FIG. 8a with cut-away corner.

In the Figures, same or functionally the same elements, if nothing to the contrary is indicated, are provided with the same reference characters.

### DESCRIPTION OF PREFERRED EMBODIMENTS

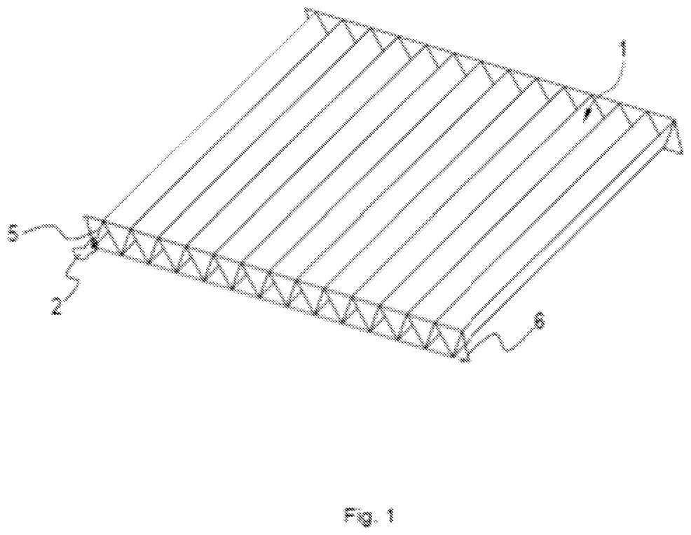

In the following, with the aid of FIGS. 1 to 6, a method for molding a sealing device 2 onto a pleated bellows 1 folded in a zigzag shape according to a first embodiment is described.

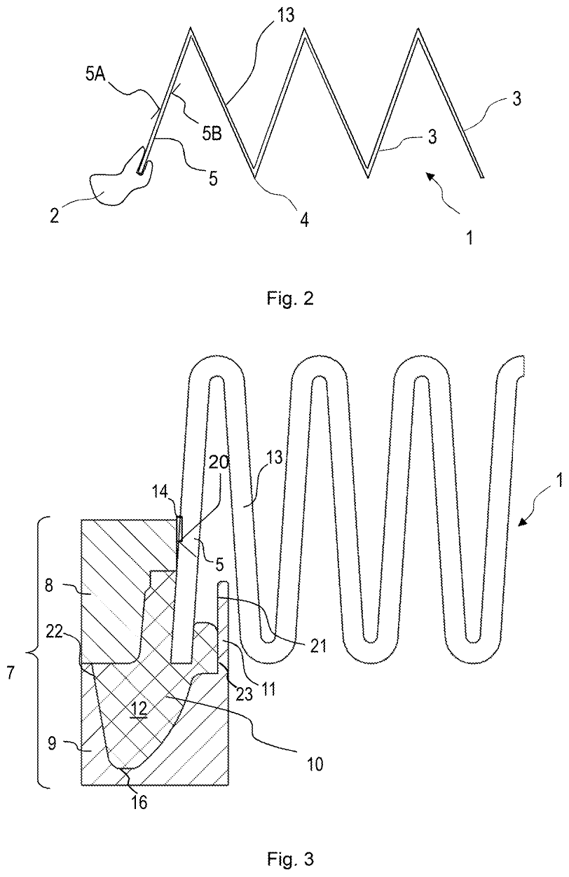

FIG. 1 shows a schematic perspective view of the pleated bellows 1 folded in a zigzag shape which is used in the method and the molded-on sealing device 2. Oppositely positioned lateral strips 6 are attached to the pleated profiles of the pleated bellows 1. The lateral strips 6 form together with the end folds 5 a circumferentially extending frame. FIG. 2 shows a partial view of FIG. 1.

As illustrated in FIG. 2, the pleated bellows 1 is a filter medium with a plurality of fold sections 3 folded at fold edges 4. The pleated bellows 1 comprises an end fold 5 which forms a fold section delimiting the pleated bellows 1 outwardly. The end fold 5 comprises an outer side 5A and an inner side 5B oppositely positioned to the outer side 5A. In particular, the outer side 5A forms an outer rim of the pleated bellows 1. The pleated bellows 1 comprises a fold section 13 neighboring the end fold 5.

The fold sections 3, including the end fold 5 and the neighboring fold section 13, are fixed by means of the lateral strip 6 which is attached to the rim-side pleated profiles of the fold sections 3, 5, 13. The lateral strip 6 is illustrated only in FIG. 1 for reasons of clarity.

Moreover, sealing device 2, which is molded onto the pleated bellows 1 by means of the method disclosed in the following, is illustrated in FIGS. 1 and 2. The sealing device 2 is molded onto the end fold 5, in particular the inner side 5B and the outer side 5A. Aside from the end fold 5, the sealing device 2 covers no additional fold sections 3 of the pleated bellows 1, in particular also does not cover the neighboring fold section 13.

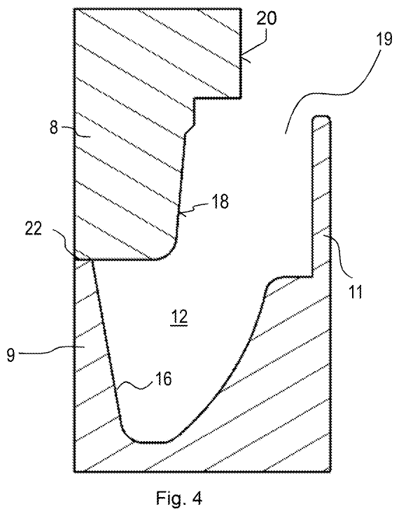

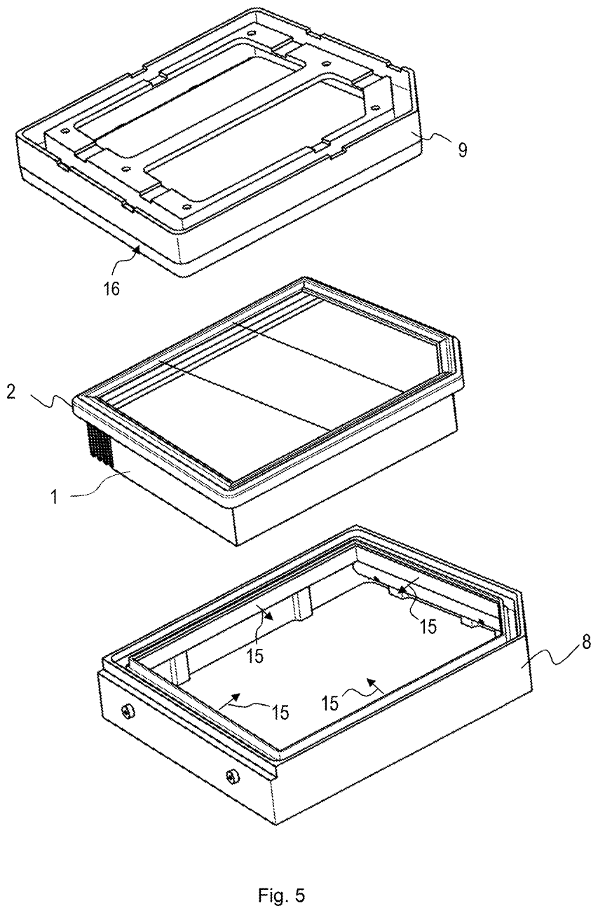

FIG. 3 shows a cross section view of a casting shell assembly 7 used in the method and of the pleated bellows 1 in a state arranged on each other and filled with a sealing material 10 during the process. FIG. 4 shows a bottom casting shell part 9 of the casting shell assembly 7 of FIG. 3. FIG. 5 shows a schematic perspective view of the principle illustration of the casting shell assembly 7 and of a filter element obtained by means of the method, in other words of the pleated bellows 1 with molded-on sealing device 2.

The casting shell assembly 7 comprises, as illustrated in FIGS. 3 to 5, a top casting shell part 8 and the bottom casting shell part 9.

In a first step of the method, the pleated bellows 1 is arranged in the top casting shell part 8. The pleated bellows 1 is in particular arranged such in the top casting shell part 8 that the outer side 5A of the end fold 5 of the pleated bellows 1 is arranged at a lateral contact surface 20 of the top casting shell part 8. For reasons of clarity, the inner side 5B and the outer side 5A are provided only in FIGS. 2 and 6 with a reference character. The top casting shell part 8 comprises, for example, spring elements 14. As indicated schematically in FIG. 3, the spring elements 14 are arranged in the top casting shell part 8. For example, the spring elements 14 are arranged at oppositely positioned inner walls in the top casting shell part 8. Upon arrangement of the pleated bellows 1 in the top casting shell part 8, the spring elements 14 engage the outer sides of the pleated bellows 1. The spring elements 14 can engage in particular at the outer side 5A, at rim-side pleated profiles and/or the lateral strip 6 of the pleated bellows 1. In FIG. 3, it is shown in an exemplary fashion how a spring element 14 engages at the outer side 5A of the pleated bellows 1. In FIG. 5, it is indicated by four arrows 15 at the top casting shell part 8 how the spring elements 14 can exert circumferential clamping forces on the pleated bellows 1. The spring elements 14 hold the pleated bellows 1 at the top casting shell part 8 so that the pleated bellows 1 is held in position at the top casting shell part 8, in particular when arranging the casting shell parts 8 and 9.

The here used directions “top” and “bottom” relate to the manufacturing process. The sealing device 2 is molded during the method onto a bottom edge of the pleated bellows 1, as illustrated in FIGS. 1, 2, and 6. In the finished product, the sealing device 2 can however be located at a top edge of the pleated bellows 1, as illustrated in FIG. 5.

In a second step of the method, the curable sealing material 10 in the liquid state is filled into the bottom casting shell part 9. The bottom casting shell part 9 comprises a circumferentially extending channel 16, as shown in cross section in FIG. 3. The liquid sealing material 10, for example, a PUR material, is filled into the circumferentially extending channel 16. For example, the liquid sealing material 10 is metered into the channel 16 by means of a metering head (not illustrated) guided by a robot.

The bottom casting shell part 9 comprises a limitation element 11 which in this embodiment is embodied as one part together with the bottom casting shell part 9 and projects thereat upwardly, as illustrated in cross section in FIG. 3. The limitation element 11 forms a rim 21 of the circumferentially extending channel 16 which, for example, projects farther upwardly than a second rim 22 of the channel 16. Here, the rim 21 is an inner rim of the circumferentially extending channel 16 and the rim 22 is an outer rim of the channel 16.

The bottom casting shell part 9 with the limitation element 11 is designed such and a quantity of filled-in liquid sealing material 10 is metered such that the limitation element 11 at the channel 16 projects upwardly past the filled-in liquid sealing material 10 after filling in the liquid sealing material 10 and prior to curing of the sealing material 10.

The limitation element 11 serves as a separation wall which separates the end fold 5 from the neighboring fold section 13 during the subsequent curing of the filled-in sealing material 10. In particular a wall 23 of the limitation element 11 forms a contour which prevents the liquid sealing material 10 from expanding during curing.

In a third step of the method, the top casting shell part 8 with the pleated bellows 1 is arranged at the bottom casting shell part 9 such that the limitation element 11 at least partially contacts the end fold 5 at the inner side.

In particular, upon arranging the casting shell parts 8 and 9 on each other, the limitation element 11 is introduced between the end fold 5 and the neighboring fold section 13 so that the limitation element 11 contacts the inner side 5B of the end fold 5. The limitation element 11 can push in this context the end fold 5 against the top casting shell part 8, in particular against the lateral contact surface 20 of the top casting shell part 8. Since the limitation element 11 is brought into direct contact with the inner side 5B of the end fold 5, the limitation element 11 delimits at the inner side 5B an expansion of the sealing material 10 in upward direction upon subsequent curing of the sealing material 10. Due to the limitation element 11, in particular the end fold 5 is separated from the neighboring fold section 13 and kept at a distance so that an expansion to the neighboring fold section 13 can be prevented during the subsequent curing of the sealing material 10.

By arranging the top casting shell part 8 at the bottom casting shell part 9, a casting chamber 12 for expansion of the sealing material 10 during curing is formed between them. The casting chamber 12 comprises in particular a volume that is formed by the circumferentially extending channel 16 into which the liquid sealing material 10 is filled. In addition to the volume which is formed by the channel 16, the casting chamber 12 comprises a top expansion region for expansion of the curing sealing material 10. The top expansion region comprises between the limitation element 11 and a corresponding wall 18 of the top casting shell part 8 an upwardly open slot 19 in which the end fold 5 is present, as can be seen in FIG. 3.

Due to the arrangement of the top casting shell part 8 with the pleated bellows 1 at the bottom casting shell part 9, the end fold 5 of the pleated bellows 1 is located between the contact surface 20 of the top casting shell part 8 and the limitation element 11 of the bottom casting shell part 9 which form the slot 19, as can be seen in FIG. 4.

In a fourth step of the method, the sealing material 10 is cured with a volume increase for forming the sealing device 2.

A quantity of filled-in liquid sealing material 10 is measured such that the sealing material 10 expands upwardly upon curing. In particular, it expands upwardly into the slot 19 in which the end fold 5 is arranged. In this way, the sealing material 10 expands at the outer side 5A and the inner side 5B of the end fold 5 so that the outer side 5A and the inner side 5B at least partially are covered by the expanding sealing material 10. FIG. 6 shows a partial cross section view of the sealing device 2 which is molded onto the pleated bellows 1 according to the method.

Upon curing, an expansion of the sealing material 10 at the inner side 5B in upward direction and in direction toward the neighboring fold section 13 is limited by the limitation element 11 which is contacting the inner side 5B of the end fold 5 and, for example, pushes the end fold 5 against the top casting shell part 8. In this way, a top section of the outer side 5A, a top section of the inner side 5B, the neighboring fold section 13, and the further fold sections 3 remain free of sealing material 10. After curing, the top casting shell part 8 is removed and the filter element comprised of pleated bellows 1 and molded-on sealing device 2 is removed from the bottom casting shell part 9.

Therefore, with the method, a filter element can be manufactured in which the sealing device 2 is molded onto the pleated bellows 1 such that it partially covers the inner side 5B and the outer side 5A and is fixedly connected to the end fold 5 of the pleated bellows 1 in this coverage region. Since the sealing device 2 does not cover the upper sections of the inner side 5B and of the outer side 5A, they are free of the sealing device 2 and can be used for a filtration of the fluid. Moreover, also the neighboring fold section 13 and the further fold sections 3 are free of the sealing device 2 and can be used for a filtration of the fluid. Consequently, with the method, a filter element can be manufactured in which all fold sections 3, 13 except for the end fold 5 are completely available for a fluid filtration.

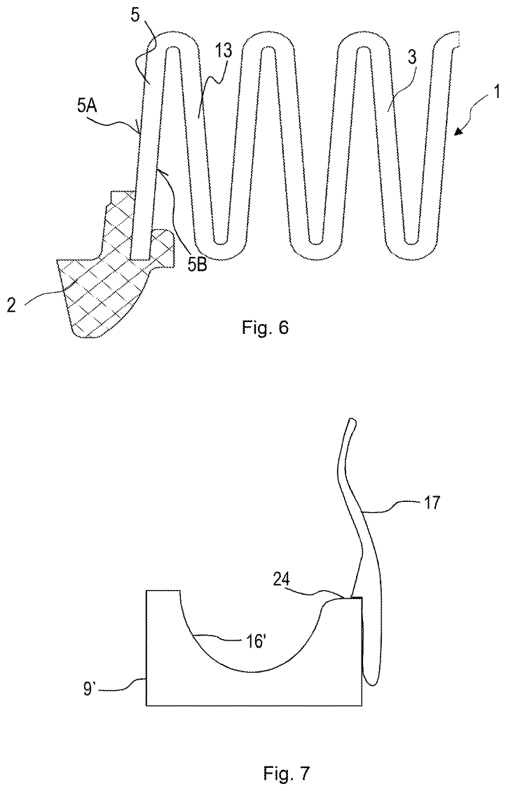

FIG. 7 shows a cross section view of a bottom casting shell part 9′ of a casting shell assembly which is used in a method for molding a sealing device 2′ onto a pleated bellows 1 according to a second embodiment. In the following, the “apostrophed” reference characters are used for explanation of the second embodiment even if they are not explicitly shown in the Figures. Elements with the same numbers correspond to those of the first embodiment. The method according to the second embodiment as well as the casting shell assembly 7′ used for this purpose are similar to the method according to the first embodiment and the casting shell assembly 7 used therein. Also, the pleated bellows 1 is similar to the pleated bellows 1 used in the method according to the first embodiment. In the following, mostly features are disclosed which differ from those of the first embodiment.

As illustrated in FIG. 7, the bottom casting shell part 9′ used in the method according to the second embodiment comprises a limitation element in the form of a spring 17 arranged thereat.

The spring 17 is arranged at an inner rim 24 of a channel 16′ and projects past the rim 24 in upward direction.

In the method according to the second embodiment, a top casting shell part 8′ (not illustrated) is arranged at the bottom casting shell part 9′. The top casting shell part 8′ according to the second embodiment is similar to the top casting shell part 8 according to the first embodiment. As in the method according to the first embodiment, a pleated bellows 1′ (not illustrated) similar to the pleated bellows 1 is arranged at the top casting shell part 8′. The pleated bellows 1′ according to the second embodiment comprises also an end fold 5′ with an inner side 5B′ and an outer side 5A′, a neighboring fold section 13′, and a further fold section 3′. When arranging the top casting shell part 8′ at the bottom casting shell part 9′, the spring 17 is introduced between the end fold 5′ and the neighboring fold section 13′ of the pleated bellows 1′. The spring 17 tapers in upward direction so that the spring 17 can be inserted easily between the end fold 5′ and the neighboring fold section 13′ even when they have a minimal distance relative to each other. Moreover, upon arranging the spring 17 between the end fold 5′ and the neighboring fold section 13′, the spring 17 is pushed against the inner side 5B′ of the end fold 5′ by a restoring force of the spring 17. In this manner, the end fold 5′ is pushed against the top casting shell part 8′ and is held at a distance to the neighboring fold section 13′. In this way, the limitation element in the form of the spring 17 can be introduced in an easy way between the end fold 5′ and the neighboring fold section 13′. Moreover, due to the spring 17 pushing against the inner side 5B′, an expansion of the sealing material during curing in upward direction along the inner side 5B′ can be limited very well. In this manner, a sealing device 2′ can be molded onto the pleated bellows 1′ such that only a small portion of the pleated bellows 1′ is covered by the sealing device 2′. In this way, a filter element with a high filtration performance can be produced.

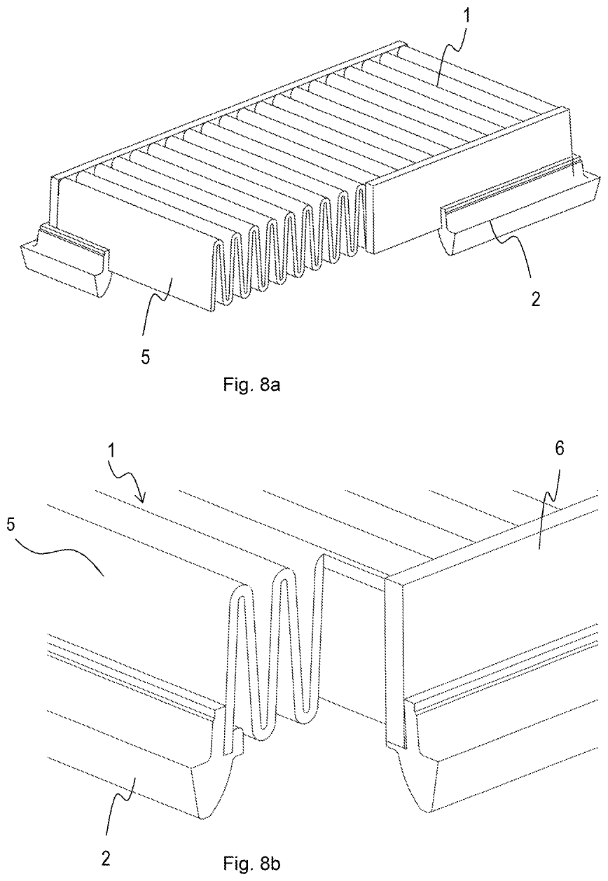

In FIGS. 8a and 8b, a filter element manufactured according to the method according to the invention is illustrated. The filter element comprises a pleated bellows 1 with lateral strips 6 and circumferentially extending sealing device 2. In FIG. 8b, the filter element is illustrated with cut-away corner so that it can be seen how the end fold 5 is embedded in the sealing device 2. The sealing device 2 engages about the end fold 5 at an inner side and at an outer side.

### EMPLOYED REFERENCE CHARACTERS

1, 1′ pleated bellows
2, 2′ sealing device
3, 3′ fold sections
4 fold edges
5, 5′ end fold
5A, 5A′ outer side
5B, 5B′ inner side
6 lateral strip
7, 7′ casting shell assembly
8, 8′ top casting shell part
9, 9′ bottom casting shell part
10 sealing material
11 limitation element
12 casting chamber
13, 13′ neighboring fold section
14 spring elements
15 clamping force
16, 16′ circumferentially extending channel
17 spring
18 wall
19 slot
20 lateral contact surface
21 rim
22 rim
23 wall
24 rim

What is claimed is:

1. A method for molding a sealing device onto an end fold of a pleated bellows folded in a zigzag shape, wherein the end fold comprises an outer side and an inner side, the method comprising:
embedding in a curable sealing material the pleated bellows arranged in a casting shell assembly, wherein embedding is limited at a rim side of the pleated bellows by a casting chamber formed by the casting shell assembly;
reducing or preventing an expansion of the curable sealing material by a limitation element contacting the inner side of the end fold.

2. The method according to claim 1, wherein the casting shell assembly comprises a top casting shell part and a bottom casting shell part, wherein the method further comprises at least one of the steps:
arranging the pleated bellows in or at the top casting shell part;
introducing the curable sealing material in an uncured state into a circumferentially extending channel of the bottom casting shell part, wherein the limitation element projects upwardly from the bottom casting shell part;
arranging the top casting shell part with the pleated bellows on the bottom casting shell part such that the limitation element contacts at least partially the inner side of the end fold;
curing of the sealing material to form the sealing device;
removing the pleated bellows with the sealing device formed thereon from the casting shell assembly.

3. The method according to claim 1, further comprising arranging the limitation element between the inner side of the end fold and a neighboring fold section of the pleated bellows neighboring the end fold so as to prevent the curable sealing material from expanding in a direction toward the neighboring fold section.

4. The method according to claim 1, wherein the curable sealing material comprises a material expanding upon curing.

5. The method according to claim 1, wherein the material expanding upon curing is a plastic material or a PUR foam.

6. The method according to claim 1, further comprising forming the casting chamber such that the curable sealing material at least partially covers the outer side and the inner side of the end fold.

7. The method according to claim 1, further comprising holding and positioning the pleated bellows at a top casting shell part of the casting shell assembly by spring elements provided at the top casting shell part.

8. The method according to claim 1, wherein the limitation element extends across at least 30% of a length of the end fold.

9. A casting shell assembly comprising:
a top casting shell part and a bottom casting shell part forming a casting chamber configured to mold a sealing device onto an end fold of a pleated bellows folded in a zigzag shape by a curable sealing material;
the bottom casting shell part comprising a channel configured to receive the curable sealing material, wherein the channel comprises an upwardly projecting limitation element configured to engage an inner side of the end fold.

10. The casting shell assembly according to claim 9, wherein the limitation element is a spring element.

11. The casting shell assembly according to claim 9, wherein the casting chamber is configured such that between the limitation element and a corresponding wall of the top casting shell part an upwardly open slot is formed and configured to receive the end fold.

12. A filter element obtained by the method of claim 1.

13. A filter element manufactured in a casting shell assembly according to claim 9.

14. A filter element comprising:
a pleated bellows of a filter medium folded in a zigzag shape and comprising at least one end fold with an inner side and an outer side;
a sealing device molded at a rim side onto the pleated bellows;
wherein the sealing device covers at least partially a rim section of the outer side and of the inner side of the at least one end fold; and
wherein the sealing device is spaced from a neighboring fold section of the pleated bellows neighboring the at least one end fold at least across a substantial length of the neighboring fold section.

15. The filter element according to claim 14, wherein the neighboring fold section is substantially free of a cured sealing material of the sealing device.

16. The filter element according to claim 14, wherein the at least one end fold is a fold section delimiting the pleated bellows outwardly, wherein the outer side of the at least one end fold forms an outer rim of the pleated bellows, and wherein the inner side of the at least one end fold is positioned opposite the outer side of the at least one end fold, wherein the neighboring fold section is a fold section folded at a fold edge relative to the at least one end fold.

17. The filter element according to claim 14, wherein the neighboring fold section is configured to be flowed through for filtration of a fluid to be filtered.

18. The filter element according to claim 14, wherein fold sections of the pleated bellows adjacent to the neighboring fold section are substantially free of the sealing device.

19. The filter element according to claim 14, wherein a cured sealing material of the sealing device is comprised of a material which expands upon curing.

20. The filter element according to claim 19, wherein the material which expands upon curing is a plastic material or a PUR foam.

21. The filter element according to claim 19, wherein the cured sealing material of the sealing device covers at least partially the outer side and the inner side of the at least one end fold.
